(19) United States
(12) Patent Application Publication
(10) Pub. No.: US 2026/0357775 A1
(43) Pub. Date: Nov. 12, 2026

(54) PNEUMATIC REMOVAL TOOL FOR FUEL INJECTORS

(71) Applicant: Chien-Hsiu Liao, Taichung City (TW)

(72) Inventor: Chien-Hsiu Liao, Taichung City (TW)

(21) Appl. No.: 19/203,154

(22) Filed: May 8, 2025

(51) Int. Cl. F02M 61/14; B25B 27/02

(52) U.S. Cl. CPC F02M 61/14; B25B 27/026

(57) ABSTRACT

A pneumatic removal tool for fuel injectors has a holding group, an air intake group, and a vibration group. The holding group has a handle, an outer shell, two connecting mounts, a fixing base, and an auxiliary rod. The connecting mounts are connected to the outer shell. The fixing base is connected to the two connecting mounts. The air intake group is connected to the holding group and has a valve base and a trigger. The vibration group is connected to the holding group and has a main shaft and a vibrating cylinder. The main shaft is securely connected to the fixing base and extends into the outer shell. The vibrating cylinder is slidably mounted on the main shaft to provide a vibration force to the main shaft, is mounted in the outer shell, and has an outer external surface non-contacted with an internal surface of the outer shell.

### BACKGROUND OF THE INVENTION

### 1. Field of the Invention

The present invention relates to a pneumatic removal tool, and more particularly to a pneumatic removal tool for fuel injectors that can be held stably, can operate safely, and can reduce operating time.

### 2. Description of Related Art

A conventional diesel engine comprises multiple fuel injectors to provide oil and gas, so that the conventional diesel engine can provide power output after combustion operation. However, the fuel injectors are prone to residue accumulation or blockage due to impurities or oil collision after a long time use, and this will affect the atomization effect of oil and gas. At this time, the fuel injectors need to be taken out from the conventional diesel engine for cleaning or replacement. Since the fuel injectors are tightly fitted on a cylinder of the conventional diesel engine, the fuel injectors cannot be easily removed manually. With reference to FIG. 12, a conventional pneumatic extraction device 50 can be used to remove the fuel injectors from the conventional diesel engine. The conventional pneumatic extraction device 50 has a vibrator 51, an air delivery pipe 52, and a switch 53. A bottom of the vibrator 51 is connected to one of the fuel injectors of the conventional diesel engine, the air delivery pipe 52 is connected to the vibrator 51 to transmit compressed air into the vibrator 51, and the switch 53 is disposed on the air delivery pipe 52 to control the transmission of the compressed air.

When the conventional pneumatic extraction device 50 is in use, the vibrator 51 is securely connected to one of the fuel injectors, and the switch 53 is open to enable the compressed air to flow into the vibrator 51 via the air delivery pipe 52. Then the corresponding fuel injector can be gradually removed from the cylinder after the vibration of the vibrator 51. Although the corresponding fuel injector can be removed from the cylinder by the conventional pneumatic extraction device 50, the user will not hold the vibrator 51 during the vibrating process of the conventional pneumatic extraction device 50 to avoid being affected by the vibration of the pneumatic extraction device 50 since the corresponding fuel injector is only connected to the bottom of the vibrator 51. Therefore, the user needs to observe the movement of the corresponding fuel injector relative to the cylinder during use to avoid safety concerns caused by the corresponding fuel injector flying outward together with the vibrator 51 when the corresponding fuel injector is separated from the cylinder. Generally, when the corresponding fuel injector is about to separate from the cylinder, the switch 53 is closed to stop the vibrator 51 from vibrating, and then the vibrator 51 is separated from the corresponding fuel injector. After the vibrator 51 is separated from the corresponding fuel injector, the corresponding fuel injector is manually pulled out from the cylinder, so as to avoid the random flying of the corresponding fuel injector along with the vibrator 51.

Although the conventional pneumatic extraction device 50 can be used to pull the fuel injectors from the cylinder, the user cannot hold the conventional pneumatic extraction device 50 stably by one hand, and the user needs to remove the fuel injector from the cylinder by two-stage operation, and this is relatively inconvenient and time-consuming. Furthermore, the user needs to pay attention to the movement of the fuel injector during the operation, and industrial safety hazard will still occur when the user does not pay attention. Therefore, the conventional pneumatic extraction device 50 really has to be improved.

To overcome the shortcomings, the present invention tends to provide a pneumatic removal tool for fuel injectors, to mitigate or obviate the aforementioned problems.

### SUMMARY OF THE INVENTION

The main objective of the present invention is to provide a fuel injector pneumatic removal tool that can be held stably, can operate safely, and can reduce operating time.

The pneumatic removal tool for fuel injectors in accordance with the present invention has a holding group, an air intake group, and a vibration group. The holding group has a handle, an outer shell, two connecting mounts, a fixing base, and an auxiliary rod. The outer shell is connected to the handle and has an open end, a closed end, and a mounting chamber. The two connecting mounts are connected to the outer shell. The fixing base is connected to the two connecting mounts. The auxiliary rod is detachably connected to the fixing base. The air intake group is connected to the holding group and has a valve base and a trigger. The vibration group is connected to the holding group and has a main shaft and a vibrating cylinder. The main shaft is securely connected to the fixing base, extends into the outer shell, and has an inner end, an outer end, and a fixing head. The vibrating cylinder is slidably mounted on the main shaft to provide a vibration force to the main shaft, is mounted in the outer shell, and has an outer external surface non-contacted with an internal surface of the outer shell.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a pneumatic removal tool for fuel injectors in accordance with the present invention;

FIG. 2 is an exploded perspective view of the pneumatic removal tool in FIG. 1;

FIG. 3 is another exploded perspective view of the pneumatic removal tool in FIG. 1;

FIG. 4 is a perspective and sectional view of the pneumatic removal tool in FIG. 1;

FIG. 5 is a cross-sectional side view of the pneumatic removal tool in FIG. 1;

FIGS. 6 to 8 are operational and cross-sectional side views of the fuel injector pneumatic removal tool in FIG. 1;

FIG. 9 is an operational perspective view of the fuel injector pneumatic removal tool in FIG. 1;

FIG. 10 is another operational perspective view of the fuel injector pneumatic removal tool in FIG. 1;

FIG. 11 is a further operational perspective view of the fuel injector pneumatic removal tool in FIG. 1; and

FIG. 12 is a perspective side view of a pneumatic extraction device in accordance with the prior art.

### DETAILED DESCRIPTION OF THE PREFERRED EMBODIMENT

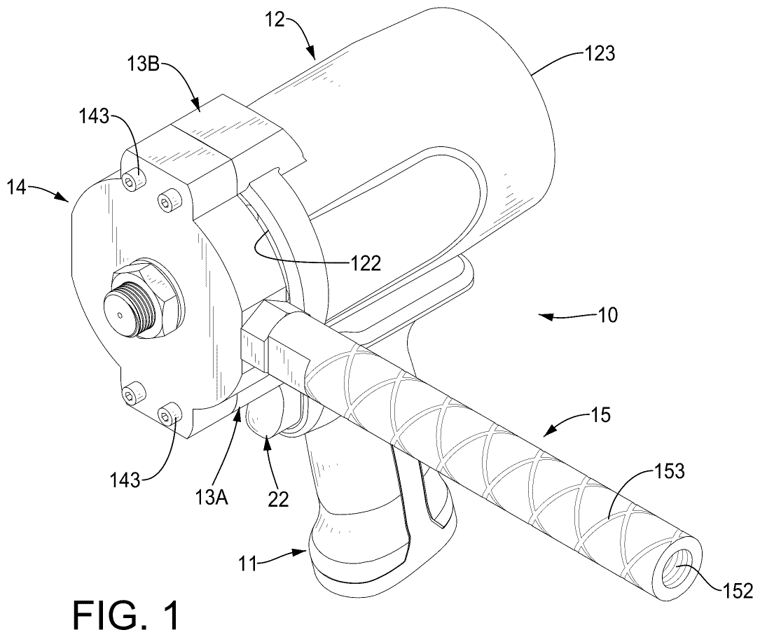

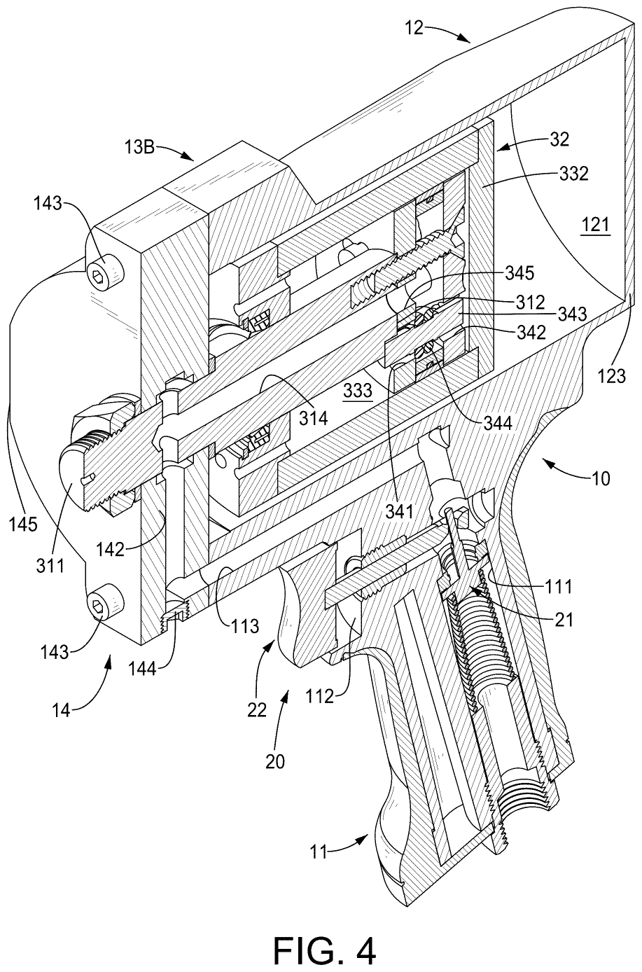

With reference to FIGS. 1 to 5, a pneumatic removal tool for fuel injectors in accordance with the present invention has a holding group 10, an air intake group 20, and a vibration group 30.

With reference to FIGS. 1, 4, and 5, the holding group 10 has a handle 11, an outer shell 12, two connecting mounts 13A, 13B, a fixing base 14, and an auxiliary rod 15. The handle 11 has an air inlet 111, a mounting recess 112, and an air outlet 113. The air inlet 111 is longitudinally formed in the handle 11 from a bottom of the handle 11. The mounting recess 112 is transversally formed in a middle portion of the handle 11 and communicates with the air inlet 111. The air outlet 113 is transversally formed in a top of the handle 11, communicates with the mounting recess 112, and selectively communicates with the air inlet 111. The outer shell 12 is connected to the handle 11, is spaced above the air outlet 113, is a hollow casing, and has a mounting chamber 121, an open end 122, and a closed end 123. The mounting chamber 121 is formed in the outer shell 12 and is spaced apart from the air outlet 113. The open end 122 and the closed end 123 are respectively disposed on two ends of the outer shell 12, and the mounting chamber 121 is disposed between the open end 122 and the closed end 123.

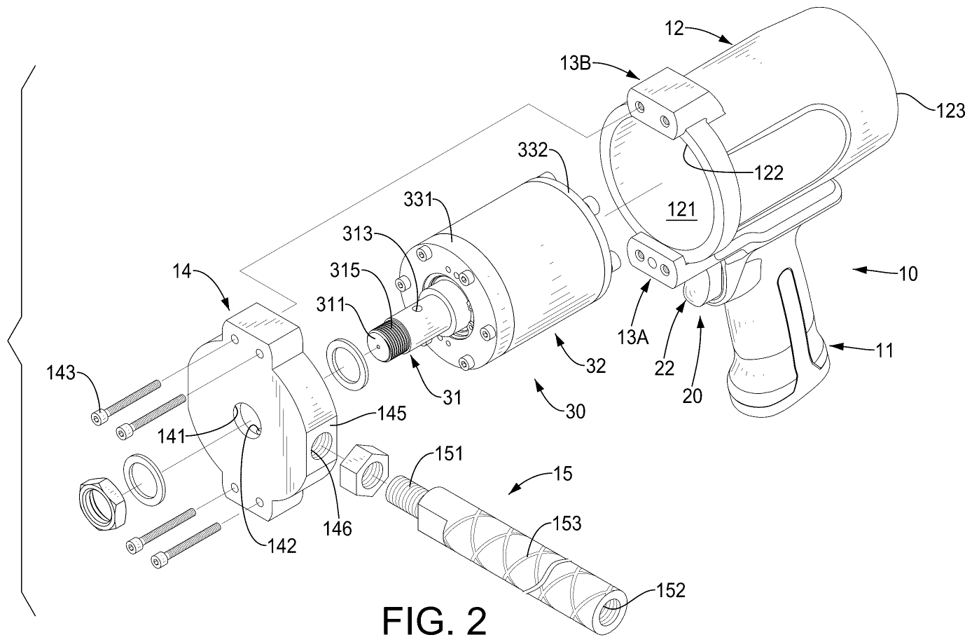

With reference to FIGS. 2, 3, and 4, the two connecting mounts 13A, 13B are connected to the outer shell 12, are disposed at a spaced interval, and are disposed at the open end 122 of the outer shell 12. Furthermore, the two connecting mounts 13A, 13B are respectively a lower connecting mount 13A and an upper connecting mount 13B. The lower connecting mount 13A is connected to the handle 11 and the outer shell 12, and the upper connecting mount 13B is connected to the outer shell 12. In addition, the air outlet 113 is formed through the lower connecting mount 13A that is connected to the handle 11 and the outer shell 12. Preferably, the handle 11, the outer shell 12, and the two connecting mounts 13A, 13B are formed as a single piece. The fixing base 14 is connected to the two connecting mounts 13A, 13B, is spaced apart from the open end 122 of the outer shell 12, and has a connecting hole 141, a communicating channel 142, multiple fasteners 143, and an anti-leak element 144. The connecting hole 141 is transversally formed through a middle portion of the fixing base 14 and has an axial direction along an axial direction of the outer shell 12. The communicating channel 142 is formed in the fixing base 14 and communicates with the air outlet 113 and the connecting hole 141. The fasteners 143 are mounted through the fixing base 14 and are connected to the two connecting mounts 13A, 13B to connect the fixing base 14 securely to the two connecting mounts 13A, 13B. The anti-leak element 144 is disposed on a bottom of the fixing base 14 to prevent compressed air from leaking outward via the fixing base 14. Furthermore, the fixing base 14 is an annular cover and has at least one abutting face 145 formed on an outer periphery of the fixing base 14. Additionally, the fixing base 14 has an assembling hole 146 radially formed through each one of the at least one abutting face 145. Preferably, the fixing base 14 has two said abutting faces 145 formed on the outer periphery thereof and two said assembling holes 146 respectively formed through the two said abutting faces 145 and respectively disposed on two sides of the handle 11.

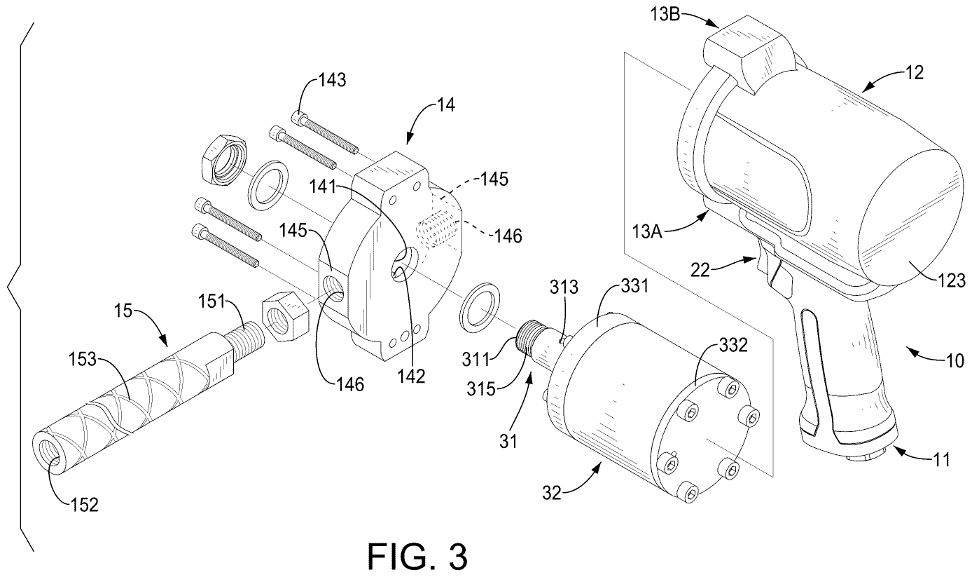

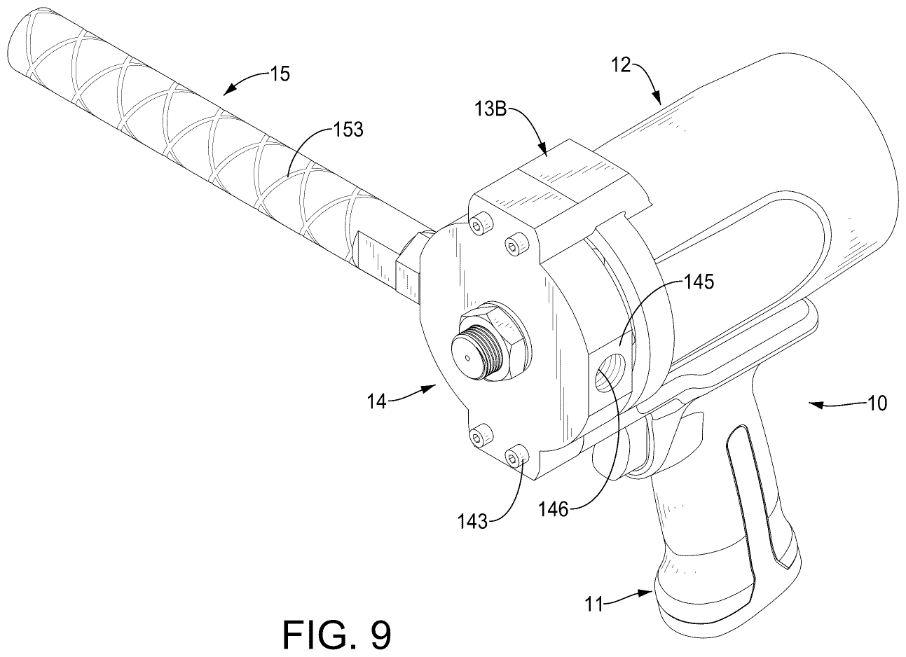

With reference to FIGS. 2 and 3, the auxiliary rod 15 is detachably connected to the fixing base 14, abuts against the at least one abutting face 145, and has an assembling head 151 and a fixing hole 152. The assembling head 151 is disposed on one of two ends of the auxiliary rod 15, is connected to one of the said assembling holes 146, and abuts against the corresponding abutting face 145. The fixing hole 152 is formed in the other one of the two ends of the auxiliary rod 15. When a user holds the holding group 10, the user holds the handle 11 with one hand and the auxiliary rod 15 with the other hand, thereby firmly and stably holding the pneumatic removal tool of the present invention. Furthermore, the auxiliary rod 15 has an anti-slip structure 153 formed on an external surface of the auxiliary rod 15 to effectively increase the friction with the user's hand to achieve a stable gripping effect. Therefore, the present invention can combine the auxiliary rod 15 with one of the assembling holes 146 of the fixing seat 14 according to the user's dominant hand or the position and habit of use, as shown in FIG. 1 or FIG. 9, so as to flexibly assemble and disassemble the device according to the user's needs.

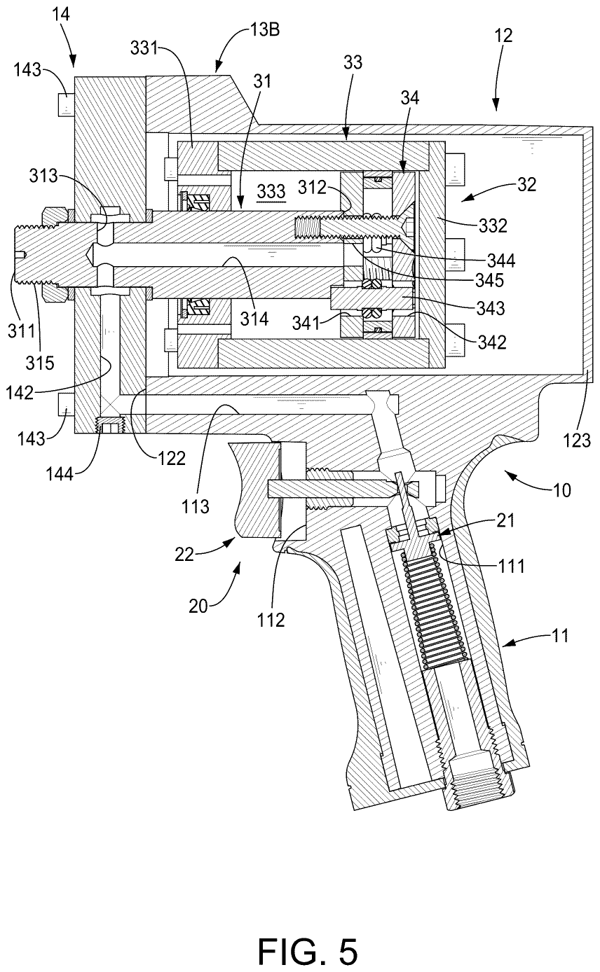

With reference to FIGS. 1 and 5, the air intake group 20 is connected to the holding group 10 and has a valve base 21 and a trigger 22. The valve base 21 is mounted in the mounting recess 112 of the handle 11 to enable the air inlet 11 to selectively communicate with the air outlet 113. The trigger 22 is pressingly connected to the valve base 21 on an external surface of the handle 11. The air inlet 111 communicates with the air outlet 113 via the mounting recess 112 when the trigger 22 is pressed by a user.

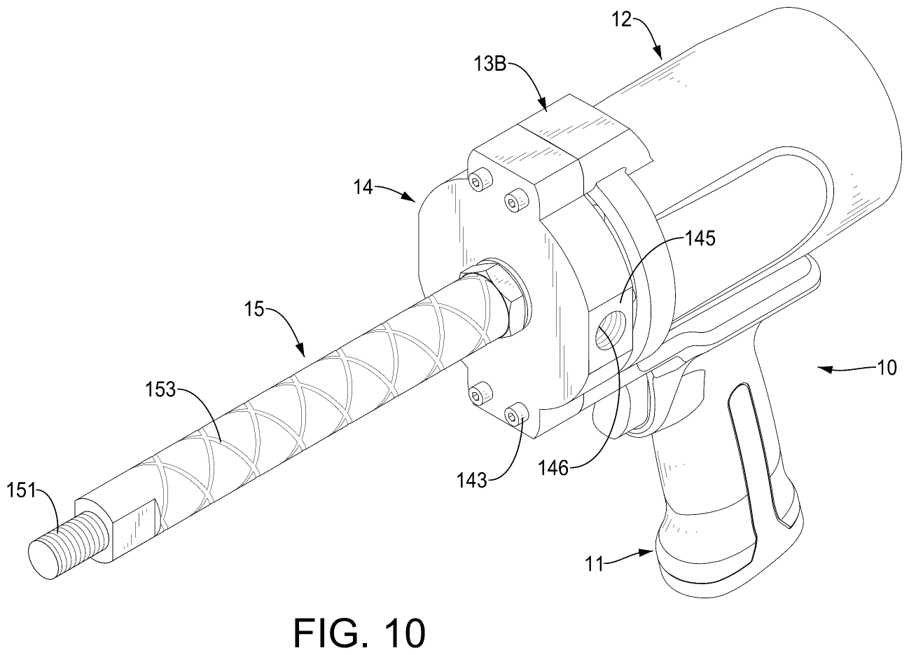

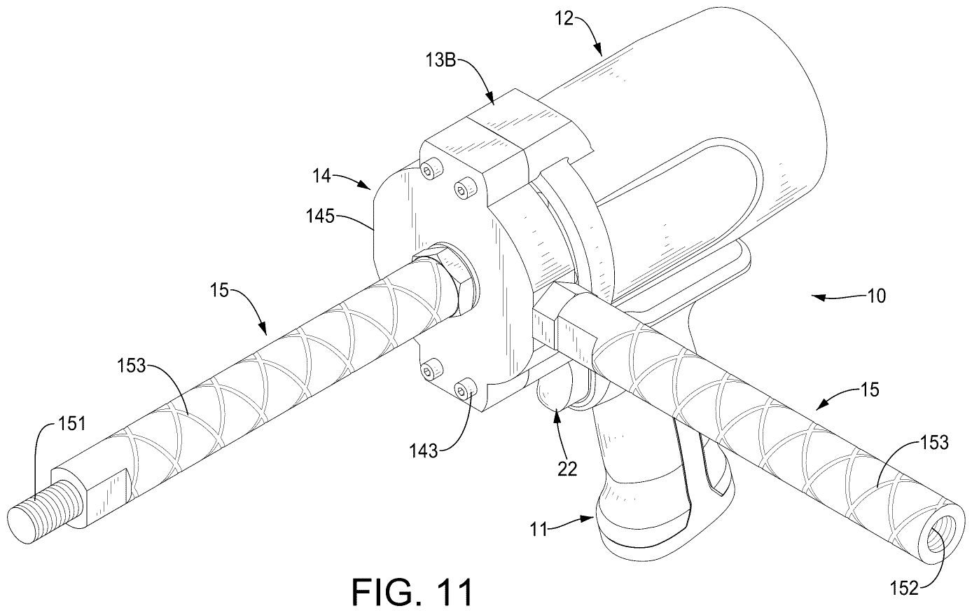

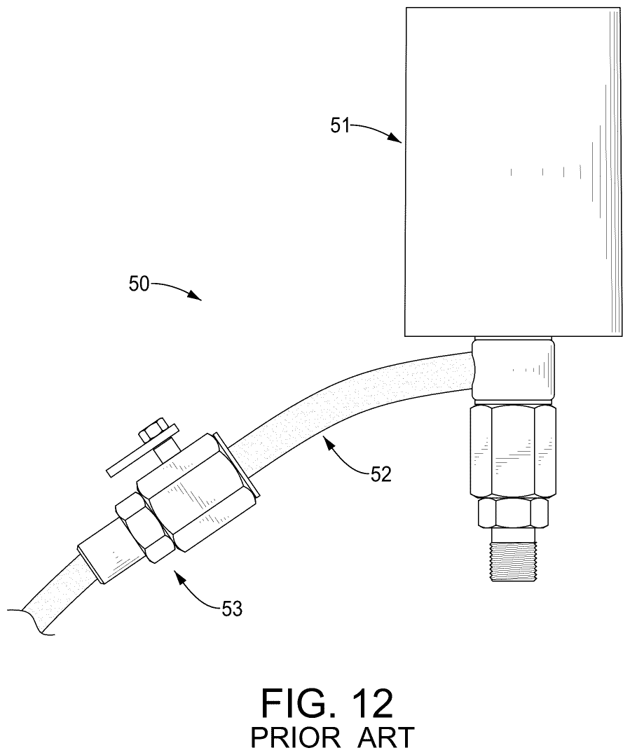

With reference to FIGS. 2 to 5, the vibration group 30 is connected to the holding group 10 and has a main shaft 31 and a vibrating cylinder 32. The main shaft 31 is securely connected to the fixing base 14, extends into the outer shell 12, and has an outer end 311, an inner end 312, a communicating hole 313, an air passage 314, and a fixing head 315. The outer end 311 of the main shaft 31 extends out of the fixing base 14 via the connecting hole 141. The inner end 312 of the main shaft 31 extends into the mounting chamber 121 of the outer shell 12 via the open end 122. The communicating hole 313 is radially formed through the main shaft 31 adjacent to the outer end 311 and communicates with the communicating channel 142. The air passage 314 is axially formed in the main shaft 31 and communicates with the communicating hole 313. The fixing head 315 is disposed on the outer end 311 and can be connected to a fuel injector of a diesel engine. Furthermore, with reference to FIGS. 1 and 10, the auxiliary rod 15 of the holding group 10 can be connected to the outer end 311 of the main shaft 31 via the fixing hole 152, and this can increase the length of the main shaft 31. Then the pneumatic removal tool of the present invention can be used in narrow and elongated spaces, and can be connected to one of the fuel injectors of a diesel engine via the assembling head 151 of the auxiliary rod 15, greatly improving the application range of the pneumatic removal tool of the present invention. Additionally, with reference to FIG. 11, the pneumatic removal tool of the present invention has two said auxiliary rods 15, one of the two said auxiliary rods 15 is connected to the fixing base 14 to provide an auxiliary grip effect, and the other one of the two said auxiliary rods 15 is connected to the main shaft 31 to provide the ability to perform removal operations in narrow spaces. Therefore, the auxiliary rod 15 of the pneumatic removal tool of the present invention can flexibly adjust the combination mode of the auxiliary rod 15 and related components according to the needs of the user or the occasion of use.

With reference to FIG. 2 to 5, the vibrating cylinder 32 is slidably mounted on the main shaft 31, is mounted in the mounting chamber 12 of the outer shell 12, and has an outer external surface non-contacted with an internal surface of the outer shell 12 such that the vibrating cylinder 32 is spaced apart from the outer shell 12. When the vibrating cylinder 32 is moved relative to the main shaft 31, the vibrating cylinder 32 will not rub against the outer shell 12. The vibrating cylinder 32 has an outer jacket 33 and a ventilating seat 34. The outer jacket 33 is slidably mounted around the main shaft 31 between the fixing base 14 and the outer shell 12, and has a front mount 331, a rear cover 332, and an air chamber 333. The front mount 331 is disposed on a front end of the outer jacket 33, is slidably mounted around the main shaft 31, and faces the fixing base 14. The rear cover 332 is disposed on a rear end of the outer jacket 33 away from the front mount 331. The air chamber 333 is formed in the outer jacket 33 between the front mount 331 and the rear cover 332.

With reference to FIGS. 2 to 5, the ventilating seat 34 is mounted securely on the inner end 312 of the main shaft 31 and is disposed in the air chamber 333 between the front mount 331 and the rear cover 332. The ventilating seat 34 allows the compressed air in the air passage 314 of the main shaft 31 to flow between the ventilating seat 34 and the rear cover 332 and between the ventilating seat 34 and the front mount 331, so that the outer jacket 33 can move relative to the main shaft 31 and the ventilating seat 34 in the mounting chamber 121 of the outer shell 12, thereby providing a vibrating force for the main shaft 31.

Furthermore, the ventilating seat 34 has multiple front through holes 341, multiple rear through holes 342, and multiple toggle levers 343. The front through holes 341 are formed through a front side of the ventilating seat 34 at spaced intervals and surrounding the air passage 314 of the main shaft 31. The rear through holes 342 are formed through a rear side of the ventilating seat 34 at spaced intervals, respectively align with the front through holes 341, and communicate with the air chamber 333 of the outer jacket 33. The toggle levers 343 are movably disposed in the ventilating seat 34, and each one of the toggle levers 343 is mounted in one of the front through holes 341 and a corresponding one of the rear through holes 342. Each toggle lever 343 has at least one washer 344 mounted around the toggle lever 343 and selectively shielding the corresponding front through hole 341 and the corresponding rear through hole 342. Preferably, the ventilating seat 34 has three said front through holes 341, three said rear through holes 342, and three said toggle levers 343. Furthermore, the ventilating seat 34 has a via hole 345 formed through a center of the front side of the ventilating seat 34 and communicating with the air passage 314 of the main shaft 31.

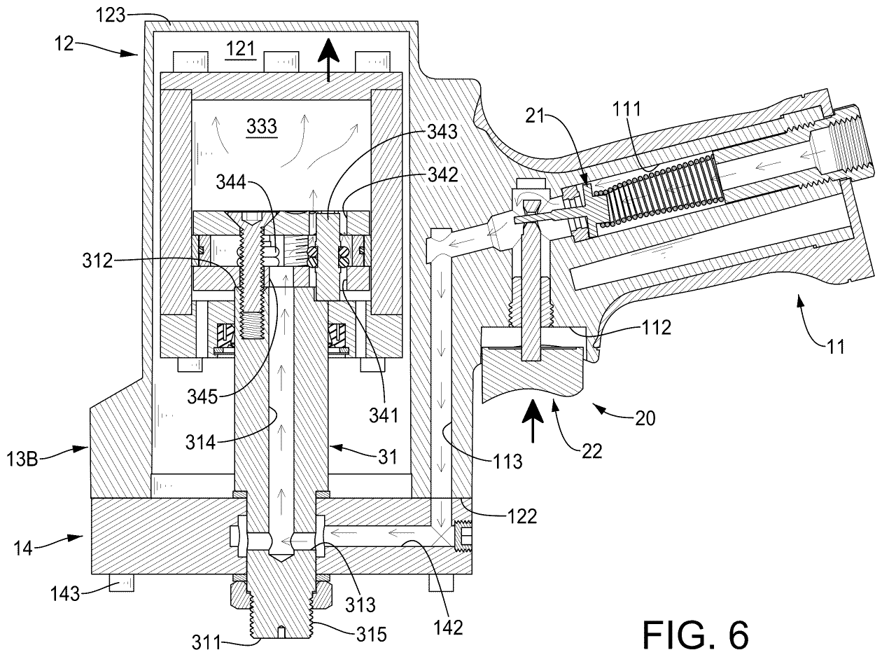

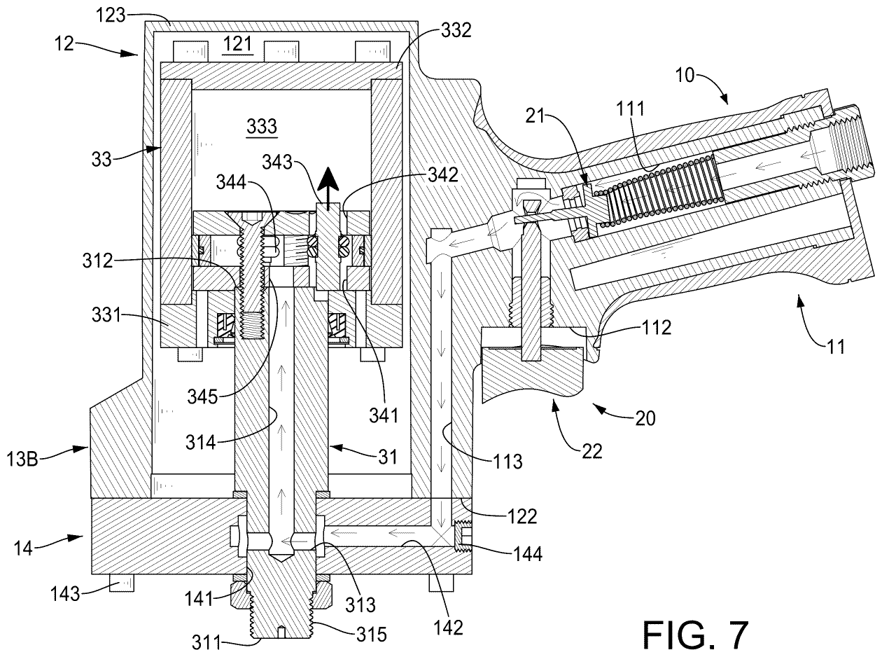

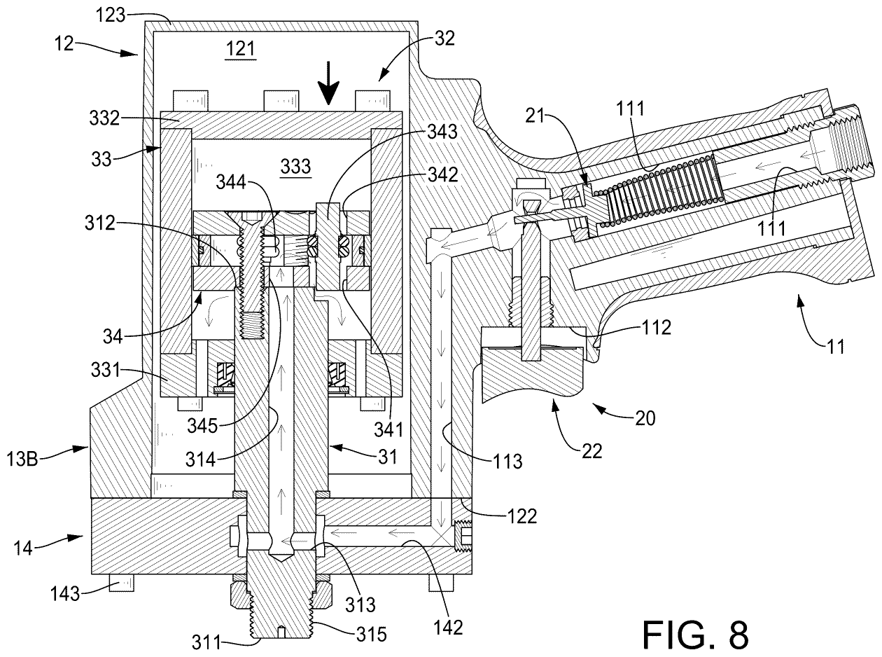

With reference to FIGS. 1 and 6, when the pneumatic removal tool of the present invention is in use, an air compressor is connected to the air inlet 111 of the handle 11 and a fuel injection of a diesel engine is securely connected to the fixing head 315 of the main shaft 31. When a user holds the handle 11 and presses the trigger 22, compressed air in the air compressor flows into the air passage 314 of the main shaft 31 via the air inlet 111, the mounting recess 112, the air outlet 113, the communicating channel 142 of the fixing base 14, and the communicating hole 312 of the main shaft 31. Then the compressed air in the air passage 314 of the main shaft 31 flows into the ventilating seat 34 via the via hole 345. At this time, with reference to FIG. 6, the washer 344 of each toggle lever 343 shields the corresponding front through hole 341, and the compressed air flows between the ventilating seat 34 and the rear cover 332 of the outer jacket 33 via the rear through holes 342. With reference to FIG. 7, the outer jacket 33 is moved relative to the outer shell 12 along the main shaft 31 by the compressed air toward the close end 123 of the outer shell 12, and the washer 344 of each toggle lever 343 shields the corresponding rear through hole 342 by the movement of the toggle lever 343. With reference to FIG. 8, the compressed air in the ventilating seat 34 flows between the ventilating seat 34 and the front mount 331 of the outer jacket 33. Then the outer jacket 33 is moved relative to the outer shell 12 along the main shaft 31 toward the open end 122 of the outer shell 12 by the compressed air until the rear cover 332 pushes the toggle levers 343 to enable the washer 344 of each toggle lever 343 to shield the corresponding front through hole 341.

By means of the washer 344 of each toggle lever 343 shielding the corresponding front through hole 341 or the corresponding rear through hole 342, the outer jacket 33 is repeatedly slid relative to the main shaft 31, and the outer jacket 33 moved relatively to the main shaft 31 can provide a vibration force to the main shaft 31 in the process of sliding, and the vibration force is transmitted to the fuel injector through the fixing head 315, so that the fuel injector can be gradually moved relative to the cylinder of the diesel engine until the fuel injector is separated from the cylinder, and the user can release the trigger 22 to complete the removal of the fuel injector.

According to the above-mentioned features and structural relationships of the pneumatic removal tool of the present invention, the user only needs to connect the main shaft 31 with the fuel injector, holds the handle 11 by one hand and presses the trigger 22, and the vibration force of the vibration group 30 can be used to separate the fuel injector from the cylinder, and this is convenient in use and easy to operate. In addition, the moving direction of the vibration group 30 can be maintained by holding the handle 11 during use, at the same time, the auxiliary rod 15 connected to the fixing base 14 can be held by the other one hand to provide a stable holding effect with two hands, and this can avoid the situation of the fuel injector separated from the cylinder and flying outwardly, effectively improving the safety of use. Furthermore, the vibration cylinder 32 is disposed in the outer shell 12 between the closed end 123 and the fixing base 14, and this can prevent the user's hands getting damaged from the vibration of the vibration cylinder 32 during operation. Additionally, when the fuel injector is separated from the cylinder, the injector can be stabilized through the handle 11 and the outer shell 12. Therefore, the pneumatic removal tool of the present invention can directly pull out the fuel injector without manual operation, which effectively reduces the time required for pulling out the fuel injector. Further, the outer external surface of the vibration cylinder 32 is non-contacted with an internal surface of the outer shell 12 such that the vibrating cylinder 32 is spaced apart from the outer shell 12. When the vibrating cylinder 32 is moved relative to the main shaft 31, the vibrating cylinder 32 will not rub against the outer shell 12, and the vibration force will not be transmitted to the handle 11 via the outer shell 12, thereby providing an effect of isolating vibration forces. Then the user can hold the handle 11 of the holding group 11 stably and comfortably.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pneumatic removal tool for fuel injectors comprising:
a holding group having
a handle;
an outer shell connected to the handle and having
an open end;
a closed end; and
a mounting chamber formed in the outer shell between the open end and the closed end;
two connecting mounts connected to the outer shell, disposed at a spaced interval, and disposed at the open end of the outer shell;
a fixing base connected to the two connecting mounts and spaced apart from the open end of the outer shell; and
an auxiliary rod detachably connected to the fixing base;
an air intake group connected to the holding group and having
a valve base mounted in the handle to control compressed air flowing into the handle; and
a trigger pressingly connected to the valve base on an external surface of the handle; and
a vibration group connected to the holding group and having
a main shaft securely connected to the fixing base, extended into the outer shell, and having
an outer end extended out of the fixing base;
an inner end extended into the mounting chamber of the outer shell via the open end; and
a fixing head disposed on the outer end and configured to connect to a fuel injector of a diesel engine; and
a vibrating cylinder slidably mounted on the main shaft to provide a vibration force to the main shaft, mounted in the mounting chamber of the outer shell, and having an outer external surface non-contacted with an internal surface of the outer shell.

2. The pneumatic removal tool as claimed in claim 1, wherein
the fixing base has
at least one abutting face formed on an outer periphery of the fixing base; and
an assembling hole radially formed through each one of the at least one abutting face;
the auxiliary rod has
an assembling head disposed on one of two ends of the auxiliary rod, connected to the assembling hole, and abutting against the at least one abutting face; and
a fixing hole formed in the other one of the two ends of the auxiliary rod.

3. The pneumatic removal tool as claimed in claim 2, wherein the pneumatic removal tool has two said auxiliary rods, one of the two said auxiliary rods is connected to the fixing base, and the other one of the two said auxiliary rods is connected to the main shaft.

4. The pneumatic removal tool as claimed in claim 1, wherein the auxiliary rod has an anti-slip structure formed on an external surface of the auxiliary rod to effectively increase the friction with a user's hand to achieve a stable gripping effect.

5. The pneumatic removal tool as claimed in claim 2, wherein the auxiliary rod has an anti-slip structure formed on an external surface of the auxiliary rod to effectively increase the friction with a user's hand to achieve a stable gripping effect.

6. The pneumatic removal tool as claimed in claim 3, wherein each one of the two auxiliary rods has an anti-slip structure formed on an external surface of the auxiliary rod to effectively increase the friction with a user's hand to achieve a stable gripping effect.

7. The pneumatic removal tool as claimed in claim 4, wherein
the handle has
an air inlet longitudinally formed in the handle from a bottom of the handle;
a mounting recess transversally formed in a middle portion of the handle and communicating with the air inlet; and
an air outlet transversally formed in a top of the handle, communicating with the mounting recess, and selectively communicating with the air inlet;
the mounting chamber of the outer shell is spaced apart from the air outlet;
the fixing base has a communicating channel formed in the fixing base and communicating with the air outlet;
the valve base is mounted in the mounting recess of the handle to enable the air inlet to selectively communicate with the air outlet; and
wherein the air inlet communicates with the air outlet via the mounting recess when the trigger is pressed.

8. The pneumatic removal tool as claimed in claim 5, wherein
the handle has
an air inlet longitudinally formed in the handle from a bottom of the handle;
a mounting recess transversally formed in a middle portion of the handle and communicating with the air inlet; and
an air outlet transversally formed in a top of the handle, communicating with the mounting recess, and selectively communicating with the air inlet;
the mounting chamber of the outer shell is spaced apart from the air outlet;
the fixing base has a communicating channel formed in the fixing base and communicating with the air outlet;
the valve base is mounted in the mounting recess of the handle to enable the air inlet to selectively communicate with the air outlet; and
wherein the air inlet communicates with the air outlet via the mounting recess when the trigger is pressed.

9. The pneumatic removal tool as claimed in claim 6, wherein
the handle has
an air inlet longitudinally formed in the handle from a bottom of the handle;
a mounting recess transversally formed in a middle portion of the handle and communicating with the air inlet; and
an air outlet transversally formed in a top of the handle, communicating with the mounting recess, and selectively communicating with the air inlet;
the mounting chamber of the outer shell is spaced apart from the air outlet;
the fixing base has a communicating channel formed in the fixing base and communicating with the air outlet;
the valve base is mounted in the mounting recess of the handle to enable the air inlet to selectively communicate with the air outlet; and
wherein the air inlet communicates with the air outlet via the mounting recess when the trigger is pressed.

10. The pneumatic removal tool as claimed in claim 7, wherein
the fixing base has a connecting hole transversally formed through a middle portion of the fixing base and communicating with the communicating channel, and having an axial direction along an axial direction of the outer shell; and
the outer end of the main shaft extends out of the fixing base via the connecting hole.

11. The pneumatic removal tool as claimed in claim 8, wherein
the fixing base has a connecting hole transversally formed through a middle portion of the fixing base and communicating with the communicating channel, and having an axial direction along an axial direction of the outer shell; and
the outer end of the main shaft extends out of the fixing base via the connecting hole.

12. The pneumatic removal tool as claimed in claim 9, wherein
the fixing base has a connecting hole transversally formed through a middle portion of the fixing base and communicating with the communicating channel, and having an axial direction along an axial direction of the outer shell; and
the outer end of the main shaft extends out of the fixing base via the connecting hole.

13. The pneumatic removal tool as claimed in claim 10, wherein the main shaft has
a communicating hole radially formed through the main shaft adjacent to the outer end and communicating with the communicating channel; and
an air passage axially formed in the main shaft and communicating with the communicating hole.

14. The pneumatic removal tool as claimed in claim 11, wherein the main shaft has
a communicating hole radially formed through the main shaft adjacent to the outer end and communicating with the communicating channel; and
an air passage axially formed in the main shaft and communicating with the communicating hole.

15. The pneumatic removal tool as claimed in claim 12, wherein the main shaft has
a communicating hole radially formed through the main shaft adjacent to the outer end and communicating with the communicating channel; and
an air passage axially formed in the main shaft and communicating with the communicating hole.

16. The pneumatic removal tool as claimed in claim 13, wherein the vibrating cylinder has
an outer jacket slidably mounted around the main shaft between the fixing base and the outer shell, and having
a front mount disposed on a front end of the outer jacket, slidably mounted around the main shaft, and facing the fixing base;
a rear cover disposed on a rear end of the outer jacket away from the front mount; and
an air chamber formed in the outer jacket between the front mount and the rear cover; and
a ventilating seat mounted securely on the inner end of the main shaft and disposed in the air chamber between the front mount and the rear cover to allow compressed air in the main shaft to flow between the ventilating seat and the rear cover and between the ventilating seat and the front mount to enable the outer jacket to move relative to the main shaft and the ventilating seat in the outer shell for providing a vibrating force to the main shaft.

17. The pneumatic removal tool as claimed in claim 14, wherein the vibrating cylinder has
an outer jacket slidably mounted around the main shaft between the fixing base and the outer shell, and having
a front mount disposed on a front end of the outer jacket, slidably mounted around the main shaft, and facing the fixing base;
a rear cover disposed on a rear end of the outer jacket away from the front mount; and
an air chamber formed in the outer jacket between the front mount and the rear cover; and
a ventilating seat mounted securely on the inner end of the main shaft and disposed in the air chamber between the front mount and the rear cover to allow compressed air in the main shaft to flow between the ventilating seat and the rear cover and between the ventilating seat and the front mount to enable the outer jacket to move relative to the main shaft and the ventilating seat in the outer shell for providing a vibrating force to the main shaft.

18. The pneumatic removal tool as claimed in claim 15, wherein the vibrating cylinder has
an outer jacket slidably mounted around the main shaft between the fixing base and the outer shell, and having
a front mount disposed on a front end of the outer jacket, slidably mounted around the main shaft, and facing the fixing base;
a rear cover disposed on a rear end of the outer jacket away from the front mount; and
an air chamber formed in the outer jacket between the front mount and the rear cover; and
a ventilating seat mounted securely on the inner end of the main shaft and disposed in the air chamber between the front mount and the rear cover to allow compressed air in the main shaft to flow between the ventilating seat and the rear cover and between the ventilating seat and the front mount to enable the outer jacket to move relative to the main shaft and the ventilating seat in the outer shell for providing a vibrating force to the main shaft.

19. The pneumatic removal tool as claimed in claim 16, wherein the ventilating seat has
multiple front through holes formed through a front side of the ventilating seat at spaced intervals and surrounding the main shaft;
multiple rear through holes formed through a rear side of the ventilating seat at spaced intervals, respectively aligning with the front through holes, and communicating with the air chamber of the outer jacket;
multiple toggle levers movably disposed in the ventilating seat, each one of the toggle levers mounted in one of the front through holes and a corresponding one of the rear through holes, and each toggle lever having at least one washer mounted around the toggle lever and selectively shielding the corresponding front through hole and the corresponding rear through hole; and
a via hole formed through the front side of the ventilating seat and communicating with the main shaft.

20. The pneumatic removal tool as claimed in claim 19, wherein the two connecting mounts are respectively a lower connecting mount and an upper connecting mount, the lower connecting mount is connected to the handle and the outer shell, and the upper connecting mount is connected to the outer shell.
